(19) United States
(12) Patent Application Publication
(10) Pub. No.: US 2009/0007276 A1
(43) Pub. Date: Jan. 1, 2009

(54) System for making it ineffective to tamper with a software application by nullifying or removing calls to a license manager because the application can be run without a call to the license manager

(76) Inventors: Kjell Ake Olsson, San Jose, CA (US); Jan Samzelius, San Francisco, CA (US)

Correspondence Address: ByteShield, Inc., 3240 Lyon Street, San Francisco, CA, 94123, US

(21) Appl. No.: 12/082,082

(22) Filed: Apr. 8, 2008

Related U.S. Application Data
(60) Provisional application No. 60/922,424, filed on Apr. 8, 2007.

(51) Int. Cl. G06F 21/00

(52) U.S. Cl. 726/27

(57) ABSTRACT

Many software applications are protected from illegal or unauthorized use by the use of a License Manager. All installations of the application are required to obtain a license from the License Manager to run. Software pirates routinely circumvent this copy protection by disabling the call to the license manager or change the code of the application so it seems to have passed the license verification. The present invention makes such efforts ineffective. The installed application cannot run, unless the call to the License Manager is made, since important code and data has been extracted from the installation and must be delivered by the License Manager. Obviously, if the call to the License Manager is disabled or manipulated, the extracted code and data will not be delivered to the installed application and it will not run.

### RELATED APPLICATIONS

The application claims the benefit of priority from U.S. Provisional Application No. 60/922,424, for “system for making it ineffective to tamper with a software application by nullifying or removing calls to a license manager because the application can not be run without a call to the license manager”, filed Apr. 8, 2007, which provisional patent application is incorporated herein in its entirety.

This application is related to U.S. patent application Ser. No. 10/844,565, for “Anti-Piracy Software Protection System and Method”, filed May 11, 2004, which patent application is incorporated by reference herein in its entirety.

### TECHNICAL FIELD

The disclosed implementations relate generally to electronic file security.

### BACKGROUND

Many solutions for limiting illegal copying of software have focused on employing a License Manager—a separate software application, which permits a given software installation to start, if it is deemed by the License Manager to have the correct and necessary rights to operate. Typically, the License Manager sends the installation a license key, allowing it to operate.

A common method today to “crack” software applications licensed or controlled by a License Manager is to tamper with the application so calls or requests to the license manager are eliminated. By extracting parts of needed code or data from the application before the installation, and keeping this information separate from the application, and only provide this data if a call is made to the license manager, the removal of the calls to the License Manager automatically renders the application useless.

### SUMMARY

The present invention takes advantage of the fact that if the application needs something to be able to run, and can only get what it needs by calling the License Manager, then it can't run unless it calls the License Manager to get validate that it is a legal and authorized installation and the server should provide it the elements necessary to run.

To create something the application needs to be able to run, the original application is run through an extraction process before being made available to the end user. The extraction process extracts parts of the code and data, and stores it together or separate with information on how the extracted information should be restored.

### DETAILED DESCRIPTION

A common method today to “crack” (i.e. remove sufficient parts of any present copy protection to allow the resultant application to be copied at will) software applications running under, a License Manager is to tamper with the application to remove or nullify the calls from the application to the License Manager. This is usually an easy task and not uncommon in many parts of the world. When completed, the “cracker” can offer the application free of charge or to a small portion of the original charge on the internet, or continue to use the product in-house but without having the application register with the License Manager. In both cases, the company that developed the application is loosing revenue.

Products exists for making it more difficult to tamper with the application so it can be disconnected from the License Manager. Most of these products come with weaknesses or drawbacks like limited tampering protection or reduced application performance.

The present invention takes advantage of the fact that if the application needs something to be able to run, and can only get what it needs by calling the License Manager, then it can't run unless it calls the License Manager to get registered.

To create something the application needs to be able to run, the application is run through an extraction process before it is made available to the end user. This is done as one of last phases of the development. The extraction process extracts parts of the code and data, and stores it together or separate with information on how the extracted information should be restored.

The extracted code and data can be kept together with the License Manager or on a separate system that preferably is a remote and “secure” system. If the system is remote and the users do not have access to the internet, the License Manager system or a separate system could service users by providing a relay service to the remote system. Further, if the system is not the License Manager, the License Manager must be able to communicate with this system.

To increase the security around the extracted code and data, the code and data can be encrypted, obfuscated or otherwise made hard to interpret or read. It can also be spread out on multiple systems.

The transportation of the extracted information to the user's system happens after a call to the License Manager, and is done over a network. This communication can be encrypted or otherwise secured.

The unpacking and use of the extracted data would be completely transparent for the user. The unpacking code needed for this process is be added to the application during the extraction process. It is imperative that this code is designed to make it difficult to intercept with debuggers or otherwise read and understand.

An important aspect of this system is that the only possible way to get the extracted information must be to also register with the License Manager. This is made possible by only providing one call for both of these functions (atomic) and to not make it possible for an application to call and just get the extracted information. Furthermore, the code path executed when a call comes from the application cannot be allowed to be tampered with. This code path must always guarantee a registration with the License Manager.

A more advanced implementation of the system includes different extracted code and data based on what license (feature) that is checked out. In this implementation, different packages of extracted data would be available for each application.

If the license type is of a type where a “heartbeat” call is needed on a regular basis to register that the application is still in use, the extraction and unpacking process would include that some of the unpacked data would only be available for a limited amount of time with a new time limit added for every “heartbeat” call that is made.

What is claimed is:

1. A method of preventing applications to run successfully if the calls to the License Manager system are removed or nullified, comprising
a. Extracting parts of the code and data of the application
b. Placing the extracted code and data on a server
c. Requiring the application to connect with the server to retrieve the extracted code and data
d. The server performing validation checks of the calling application and delivering the extracted code and data only if it determines that the application is legal, authorized and has permission.

2. The method of claim 1, wherein the extracted code and data in the application is replaced with code, essentially random, but seems correct.

3. The method of claim 1, wherein the extracted code and data is essential to the execution of the logic of the application.

4. The method of claim 1, wherein the parts of the code and data are extracted prior to assembly of the application and, thus, these parts are not delivered to the end user, prior to registration and activation.

5. The method of claim 1, wherein the communication between the local installation and server is protected with secure protocols.

6. The method of claim 1, wherein multiple validation checks of the local installation are performed by the server, including, but not limited to: Hardware IDs, such Hard Drive serial number, ID number of the software installation itself, ID number of the previously delivered extracted code and data (for revalidation).
